(19) United States
(12) Patent Application Publication
(10) Pub. No.: US 2025/0056368 A1
(43) Pub. Date: Feb. 13, 2025

(54) CELL SELECTION IN CONDITIONAL HANDOVER

(71) Applicant: Apple Inc., Cupertino, CA (US)

(72) Inventors: Mayank Kailash Agrawal, San Jose, CA (US); Jooyeon Lee, San Jose, CA (US); Srirang A. Lovlekar, Fremont, CA (US); Swapnil Santosh Nivendkar, Santa Clara, CA (US)

(21) Appl. No.: 18/793,731

(22) Filed: Aug. 2, 2024

Related U.S. Application Data
(60) Provisional application No. 63/531,784, filed on Aug. 9, 2023.

(51) Int. Cl. H04W 36/36; H04B 17/318; H04W 36/00

(52) U.S. Cl. CPC H04W 36/362; H04B 17/328; H04W 36/0085

(57) ABSTRACT

Disclosed are methods, systems, and computer-readable medium to perform operations including: receiving, from a source base station, a configuration message for conditional handover, the configuration message comprising respective bandwidths and subcarrier spacings corresponding to respective a plurality of candidate cells; measuring reference signal received power (RSRP) for each of the plurality of candidate cells; selecting a target cell from the plurality of candidate cells for conditional handover based on one or more of the bandwidth, the subcarrier spacing, or the RSRP; and performing conditional handover with a base station in the target cell.

### CROSS-REFERENCE TO RELATED APPLICATION

This application claims priority to U.S. Provisional Patent Application No. 63/531,784, filed Aug. 9, 2023, the entire contents of which are incorporated herein by reference.

### BACKGROUND

Wireless communication networks provide integrated communication platforms and telecommunication services to wireless user devices. Example telecommunication services include telephony, data (e.g., voice, audio, and/or video data), messaging, internet access, and/or other services. The wireless communication networks have wireless access nodes that exchange wireless signals with the wireless user devices using wireless network protocols. Example wireless communication networks include code division multiple access (CDMA) networks, time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### SUMMARY

Handover is a process for switching base stations and/or cells associated with a user equipment (UE). Types of handovers include intra-cell, intra-eNodeB/gNodeB, inter-eNodeB/gNodeB, and inter-RAT (Radio Access Technology) handovers.

In some implementations, a UE can receive a list of candidate cells (e.g., information about base stations serving the candidate cells) through a radio resource control (RRC) reconfiguration message from a serving cell (e.g., from a source base station in the serving cell), and select a suitable target cell from the list of candidate cells. The UE can trigger handover-complete for one of the candidate cells if one or more handover criteria are met. For example, multiple candidate cells can meet handover criteria based on reference signal received power (RSRP) thresholds (e.g., handover event A3 or event A5). Event A3 is triggered when the signal of a neighbor cell becomes more than an offset amount better than the signal of the serving cell. Event A5 is triggered when the signal of the serving cell becomes worse than a first threshold, while the signal of a neighboring cell becomes better than a second threshold.

Selecting a target cell using only the RSRP criterion may result in a suboptimal cell being selected, for example, when the UE has high throughput requirements, such as an ongoing data session. A suboptimal selection may affect the overall user experience. As described in greater detail in the following sections, in some implementations, the selection of the target cell for conditional handover can be optimized by selecting the target cell based on bandwidth, subcarrier spacing, and RSRP.

In the disclosed implementations, the UE uses a difference in RSRP between the cell currently serving the UE and each of the candidate cells as one of the factors for the selection in conditional handover. The UE takes into consideration several other factors in addition to the RSRP to select the best possible candidate cell to enhance the user experience. The additional factors include bandwidth and subcarrier spacing, among other suitable factors.

Selecting the target cell based on a combination of factors such as bandwidth, subcarrier spacing, and/or difference in RSRP can increase throughput and user performance once the UE switches to the target cell. When users have higher throughput, the active time for the users can be reduced and battery power can be saved when the target cell selection is based on factors such as bandwidth requirement or subcarrier spacing, in addition or as an alternative to RSRP or other power consumption metrics.

In accordance with one aspect of the present disclosure, a method is performed by a user equipment (UE). The method comprises receiving, from a source base station in a serving cell, a configuration message for conditional handover, the configuration message comprising respective bandwidths and subcarrier spacings corresponding to respective a plurality of candidate cells; measuring reference signal received power (RSRP) for one or more of the plurality of candidate cells; selecting one of the plurality of candidate cells as a target cell for conditional handover based on one or more of the bandwidth, the subcarrier spacing, or the RSRP; and performing conditional handover to the target cell.

The details of one or more embodiments of these systems and methods are set forth in the accompanying drawings and the description below. Other features, objects, and advantages of these systems and methods will be apparent from the description and drawings, as well as from the claims.

### BRIEF DESCRIPTION OF THE FIGURES

FIG. 1 illustrates a wireless network, according to some implementations.

FIG. 2 illustrates a message sequence diagram for conditional handover, according to some implementations.

FIG. 3 illustrates a flowchart of an example process for conditional handover, according to some implementations.

FIG. 4 illustrates a user equipment (UE), according to some implementations.

FIG. 5 illustrates an access node, according to some implementations.

FIG. 6 is a block diagram of an example apparatus, according to some implementations.

### DETAILED DESCRIPTION

Conditional handover allows a UE to trigger handover to a target cell if the target cell meets certain criteria. The criteria can include bandwidth, subcarrier spacing, and RSRP for a plurality candidate cells. A source base station sends handover requests to base stations in the candidate cells, and receives handover request acknowledgements from the candidate cell base stations, including information about various handover criteria, such as bandwidth or subcarrier spacing, of the candidate cells. The source base station sends a radio resource control (RRC) reconfiguration message to the UE with a list of possible candidate cells for conditional handover. Upon receiving the RRC reconfiguration message from the source base station, the UE selects the target cell from the list of possible candidate cells based on one or more handover criteria information obtained from the RRC reconfiguration message. The UE then sends an RRC reconfiguration complete message to a base station in the target cell.

The UE can obtain information about the bandwidth and subcarrier spacing supported by the candidate cells from the RRC reconfiguration message, and can configure the physical layer to measure and report RSRP for each of the candidate cells. Upon receiving RSRP measurements for the candidate cells, the UE evaluates if the measurement criterion, e.g., RSRP threshold value, is met. When multiple cells meet the criterion, the UE can select the target cell based on a weighted sum of a plurality of handover factors (e.g., plurality of bandwidth, subcarrier spacing, RSRP). Appropriate weights can be applied to each of the factors for selecting the target cell. The weights can be determined based on how the UE is currently using the network, such as an ongoing data session. The UE performs conditional handover on the selected target cell.

In some implementations, the target cell can be selected within a selection time window, wherein a strongest candidate can be selected at the end of the time window. For example, RSRP measurements can be received for a period, and the target cell can be selected based on the RSRP measurements across the period (e.g., maximum or average RSRP measurements). In some examples, the UE can receive multiple Radio Resource Control (RCC) messages within a selection window (e.g., at the beginning and the end of the window), and select the target cell based on the handover factors across the selection window (e.g., maximum or average values of the handover factors). Since the selection window can introduce some delay in selecting the strongest candidate, the selection window may be applicable only if the RSRP of the serving cell is above a certain threshold.

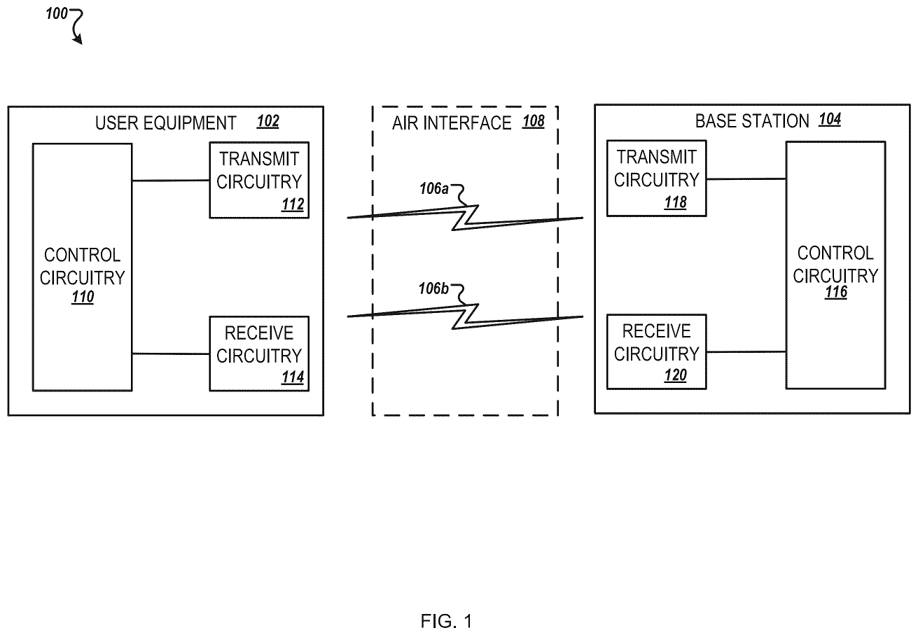

FIG. 1 illustrates a wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates Long Term Evolution (LTE) and Fifth Generation (5G) New Radio (NR) communication standards as defined by the Third Generation Partnership Project (3GPP) technical specifications. For example, the wireless network 100 may be an E-UTRA (Evolved Universal Terrestrial Radio Access)-NR Dual Connectivity (EN-DC) network, or a NR-EUTRA Dual Connectivity (NE-DC) network. However, the wireless network 100 may also be a Standalone (SA) network that incorporates only 5G NR. Furthermore, other types of communication standards are possible, including future 3GPP systems (e.g., Sixth Generation (6G)) systems, Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, laptop computers, smartphones, tablet computers, machine-type devices such as smart meters or specialized devices for healthcare, intelligent transportation systems, or any other wireless devices with or without a user interface. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by antennas integrated with the base station 104. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations such as those described elsewhere in this disclosure related to a UE. For instance, the control circuitry 110 can select a target cell for conditional handover based on a plurality of factors, such as bandwidth, subcarrier spacing, and RSRP.

The transmit circuitry 112 can perform various operations described in this specification. For example, the transmit circuitry 112 can transmit an RRC reconfiguration complete to a base station in the target cell. Additionally, the transmit circuitry 112 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 can perform various operations described in this specification. For instance, the receive circuitry 114 can receive a configuration message for the conditional handover (e.g., RRC reconfiguration message) from the base station 104. Additionally, the receive circuitry 114 may receive a plurality of multiplexed downlink physical channels from the air interface 108 and relay the physical channels to the control circuitry 110. The plurality of downlink physical channels may be multiplexed according to TDM or FDM along with carrier aggregation. The transmit circuitry 112 and the receive circuitry 114 may transmit and receive both control data and content data (e.g., messages, images, video, etc.) structured within data blocks that are carried by the physical channels.

FIG. 1 also illustrates the base station 104. In implementations, the base station 104 may be an NG radio access network (RAN) or a 5G RAN, an E-UTRAN, a non-terrestrial cell, or a legacy RAN, such as a UTRAN or GERAN. As used herein, the term “NG RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The transmit circuitry 118 may transmit downlink physical channels including a plurality of downlink subframes. The receive circuitry 120 may receive a plurality of uplink physical channels from various UEs, including the UE 102.

In FIG. 1, the one or more channels 106A, 106B are illustrated as an air interface to enable communicative coupling, and can be consistent with cellular communications protocols, such as a GSM protocol, a CDMA network protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Control Channel (PSCCH), a Physical Sidelink Discovery Channel (PSDCH), and a Physical Sidelink Broadcast Channel (PSBCH).

As described above, in some implementations, the UE selects a target cell for handover based on a combination of bandwidth, subcarrier spacing, and RSRP. The UE receives an RRC reconfiguration message that includes information corresponding to a plurality of candidate cells (e.g., physical cell identifiers of individual candidate cells). The RRC reconfiguration message also includes information about bandwidth and subcarrier spacing of the candidate cells. For example, an RRC reconfiguration message for conditional handover as described in TS 38.331 can include bandwidth and subcarrier spacing for initial and dedicated bandwidth for neighbor cell having a physical cell identifier (PCI) 11, as illustrated below:

```
nonCriticalExtension {
    nonCriticalExtension {
      nonCriticalExtension {
      nonCriticalExtension {
        conditionalReconfiguration-r16 {
        attemptCondReconfig-r16 true,
        condReconfigToAddModList-r16 {
        {
          condReconfigId-r16 1,
          condExecutionCond-r16 {
          1
        },
          spCellConfig {
            servCellIndex 0,
              reconfigurationWithSync {
              spCellConfigCommon {
                physCellId 11,
                downlinkConfigCommon {
                frequencyInfoDL {
                absoluteFrequencySSB 424090,
                frequencyBandList {
                  1
                },
                absoluteFrequencyPointA 424000,
          scs-SpecificCarrierList {
          {
    offsetToCarrier 0,
    subcarrierSpacing kHz30,
    carrierBandwidth 25
    }
  }
},
  initialDownlinkBWP {
    genericParameters {
    locationAndBandwidth 2,
    subcarrierSpacing kHz30,
    cyclicPrefix extended
    },
spCellConfigDedicated {
    initialDownlinkBWP {
    },
    downlinkBWP-ToAddModList {
    {
    bwp-Id 1,
    bwp-Common {
      genericParameters {
          locationAndBandwidth 0,
          subcarrierSpacing kHz30
        }
      },
      bwp-Dedicated {
        pdsch-Config setup : {
            dmrs-DownlinkForPDSCH-MappingTypeA setup : {
```

As shown by the example section of RRC reconfiguration message illustrated above, the information element (IE) downlinkConfigCommon includes an IE FrequencyInfoDL and an IE initialDownlinkBWP. The IE FrequencyInfoDL, which provides parameters of a downlink carrier, can include the frequency of the synchronization signal block (absoluteFrequencySSB), the subcarrier spacing (subcarrierSpacing), and the carrier bandwidth (carrierBandwidth) for a serving base station. For example, the subcarrier spacing can be 30 kilohertz (kHz) and the carrier bandwidth can be 25 megahertz (MHz), as shown in the example above. The IE initialDownlinkBWP, which includes the initial downlink BWP configuration for the serving base station, can also include bandwidth (locationAndBandwidth) and subcarrier spacing (subcarrierSpacing). For example, the carrier bandwidth can be 2 MHz and the subcarrier spacing can be 30 kHz, as shown in the example above. The IE downlinkBWP-ToAddModList, which includes a list of additional downlink bandwidth parts to be added or modified, can include bandwidth (locationAndBandwidth) and subcarrier spacing (subcarrierSpacing). For example, the carrier bandwidth can be 0 MHz and the subcarrier spacing can be 30 kHz, as shown by the example above.

The RSRP of the serving and candidate cells can be measured by the UE physical layer. The UE radio resource control layer (NRRC) layer can receive the measured RSRP, and the UE can calculate the difference between the RSRP of the serving cell and each candidate cell.

In some implementations, the UE can scale the factors (e.g., bandwidth, subcarrier spacing, different in RSRP) so that the raw values do not disproportionately influence any of the factors. For example, a candidate cell with a high bandwidth (e.g., 100 MHz) could be prioritized too highly if the bandwidth value is not scaled. In some examples, the bandwidth for FR1 and FR2 can be scaled using raw frequency bandwidths and the corresponding values according to Table 1 below, without limitation.

TABLE 1

| Bandwidth | Value to | Bandwidth | Value to |
|---|---|---|---|
| (FR1) | be used | (FR2) | be used |
| 5 MHz | 1 | 50 MHz | 1 |
| 10 MHz | 1.5 | 100 MHz | 2 |
| 15 MHz | 2 | 200 MHz | 4 |
| 20 MHz | 2.5 | 400 MHz | 8 |
| 25 MHz | 3 | | |
| 30 MHz | 3.5 | | |
| 35 MHz | 4 | | |
| 40 MHz | 4.5 | | |
| 45 MHz | 5 | | |
| 50 MHz | 5.5 | | |
| 60 MHz | 6 | | |
| 70 MHz | 6.5 | | |
| 80 MHz | 7 | | |
| 90 MHz | 7.5 | | |
| 100 MHz | 8 | | |

In some examples, the subcarrier spacing for FR1 and FR2 can be scaled using raw frequency subcarrier spacings and the corresponding values according to Table 2 below.

TABLE 2

| Subcarrier Spacing | Value to | Subcarrier Spacing | Value to |
|---|---|---|---|
| (FR1) | be used | (FR2) | be used |
| 15 MHz | 1 | 60 MHz | 1 |
| 30 MHz | 2 | 120 MHz | 2 |
| 60 MHz | 4 | 480 MHz | 8 |

In some examples, the difference in RSRP (e.g., candidate cell RSRP-serving cell RSRP) can be scaled using raw signal strength measurements and the corresponding values according to Table 3 below.

TABLE 3

| | |
|---|---|
| Difference in RSRP | |
| (Candidate cell − Serving cell) | Value to be used |

| | | |
|---|---|---|
| <=5 | dBm | 1 |
| 6 | dBm | 1.2 |
| 7 | dBm | 1.4 |
| 8 | dBm | 1.6 |
| 9 | dBm | 1.8 |
| 10 | dBm | 2 |
| 11 | dBm | 2.2 |
| 12 | dBm | 2.4 |
| 13 | dBm | 2.6 |
| 14 | dBm | 2.8 |
| 15 | dBm | 3 |
| 16 | dBm | 3.2 |
| 17 | dBm | 3.4 |
| 18 | dBm | 3.6 |
| 19 | dBm | 3.8 |
| 20 | dBm | 4 |

In some implementations, the UE uses a weighted combination of the assigned values for the various factors, e.g., bandwidth, subcarrier spacing, and RSRP as noted above, to select the target cell. The weighted combination can be a combination of bandwidth, subcarrier spacing and RSRP; bandwidth and RSRP; subcarrier spacing and RSRP; or other factors. The weights can be selected based on a type of service of the UE (e.g., a voice or data service accessed by the user). The UE can receive service information from an application portal. For example, a control layer of the UE can receive the service information from an application layer of the UE. In some examples, the RRC reconfiguration can access quality of service (QOS) information to obtain the service information. For example, a UE being used to access application data (e.g., LTE or 5G NR) may prioritize having higher bandwidth, while another UE with no application activity may prioritize better coverage. The types of service can include one or more of whether there is any active data session (e.g., video calls, streaming games or audiovisual media, downloading files) that is ongoing, whether there is any active voice call that is ongoing, or whether there is only mobility (e.g., the UE is moving and not doing any voice call or any data session).

In some implementations, numerical weights are provided to the various factors such that the sum of the weights adds up to one. For example, the weights can be selected for a corresponding type of service using the weights according to Table 4 below.

TABLE 4

| | X | Y (Subcarrier | Z (Difference |
|---|---|---|---|
| Type of Service | (Bandwidth) | Spacing | in RSRP) |
| Active Data Session | 0.4 | 0.3 | 0.3 |
| Active Voice Call | 0.3 | 0.4 | 0.3 |
| Mobility (no activity) | 0.2 | 0.2 | 0.6 |

In some implementations, a final value for each candidate cell is calculated based on X*(Bandwidth)+Y*(Subcarrier Spacing)+Z*(RSRP Difference) wherein X, Y & Z are weights decided based on the type of service. The UE can use the final value as a score to select the base station with the highest final value as the target cell. For example, when the type of service is mobility (e.g., no data activity or voice call), the weights X=0.2, Y=0.2, and Z=0.6 can be used to calculate final values for candidate cells (e.g., base stations) according to Table 5 below.

TABLE 5
Simulation Scenario 1 ( X = 0.2, Y = 0.2, Z = 0.6)

| | Type of | | | Sub-Carrier | Difference | | | Z*Diff in | Final |
|---|---|---|---|---|---|---|---|---|---|
| Type | Service | Candidate | Bandwidth | Spacing | in RSRP | X*Bandwidth | Y*SCS | RSRP | Value |
| FR1 | Mobilky | Candidate cell#1 | 20 MHz | 15 KHz | 3 dBm | 0.5 | 0.2 | 0.6 | 1.3 |
| FR1 | Mobility | Candidate cell#2 | 10 MHz | 15 Khz | 6 dBm | 0.3 | 0.2 | 0.72 | 1.22 |
| FR1 | Mobility | Candidate cell#3 | 40 MHz | 30 KHz | 11 dBm | 0.9 | 0.4 | 1.32 | 2.62 |
| FR1 | Mobility | Candidate cell#4 | 60 MHz | 30 KHz | 9 dBm | 1.2 | 0.4 | 1.08 | 2.68 |
| FR1 | Mobility | Candidate cell#5 | 50 MHz | 30 Khz | 10 dBm | 1.1 | 0.4 | 1.2 | 2.7 |

The final values (e.g., scores) can be calculated using a weighted sum based on the three factors. The UE can select the candidate cell 5 as the target cell based on the final values. If the target cell is selected using only the difference in RSRP, candidate cell 3 would be selected as the target cell. However, candidate cell 5 may be more efficient in terms of bandwidth and subcarrier spacing compared to candidate cell 3, such that selecting candidate cell 5 as the target cell can help enhance the user experience. For example, the difference in RSRP for candidate cell 3 is only one decibel higher than candidate cell 5, while candidate cell 5 has a bandwidth that is 10 MHz higher than candidate cell 3. When all three factors are weighted, candidate cell 5 has the highest final value, and can be selected over candidate cell 3.

As another example, when the type of service is data, the weights X=0.4, Y=0.2, and Z=0.6 can be used to calculate final values for candidate cells (e.g., base stations) according to Table 6 below. It is to be noted that the weights used in Tables 5 and 6 are not meant to be limiting; different implementations can use other values of weights X, Y, and Z.

TABLE 6
Simulation Scenario 2 (X = 0.4, Y = 0.3, Z = 0.3)

| | Type of | | | Sub-Carrier | Difference | | | 2*Diff | Final |
|---|---|---|---|---|---|---|---|---|---|
| Type | Service | Candidate | Bandwidth | Spacing | in RSRP | X*Bandwidth | Y*SCS | in RSRP | Value |
| FR1 | Data | Candidate cell#1 | 20 MHz | 15 KHz | 3 dBm | 1 | 0.3 | 0.3 | 1.6 |
| FR1 | Data | Candidate cell#2 | 10 MHz | 15 Khz | 6 dBm | 0.6 | 0.3 | 0.36 | 1.26 |
| FR1 | Data | Candidate cell#3 | 40 MHz | 30 KHz | 11 dBm | 1.8 | 0.6 | 0.66 | 3.06 |
| FR1 | Data | Candidate cell#4 | 60 MHz | 30 KHz | 9 dBm | 2.4 | 0.6 | 0.54 | 3.56 |
| FR1 | Data | Candidate cell#5 | 50 MHz | 30 Khz | 10 dBm | 2.2 | 0.6 | 0.6 | 3.4 |

The UE can select the candidate cell 4 as the target cell based on the final values. When the target cell is selected using only the difference in RSRP, candidate cell 3 would be selected as the target cell. However, candidate cell 4 may be more efficient in terms of bandwidth. When bandwidth and subcarrier spacing are considered in addition to RSRP, candidate cell 4 has the highest final value from the weighted sum, and cell 4 can be selected over candidate cell 3.

In some implementations, the radio type (e.g., FR1 or FR2) may be used as a factor for selecting the target cell. For example, the final value could be increased (e.g., by 0.1, 0.2) if radio type FR2 is available. In some examples, the target cell can be selected from candidate cells supporting FR2 when FR2 is available (e.g., the UE hardware and/or RAN infrastructure supports FR2).

In some implementations, the UE can determine the weights (e.g., one or more of X, Y, or Z) dynamically based on predictive traffic pattern algorithms. For example, when the type of service is data, the UE can determine how the data is being used (e.g., streaming, downloading files). The UE can model future data usage based on the current data usage and historical trends. For example, the model can be trained to predict data usage using machine learning and historical data. In some examples, the model can be based on statistical regressions of historical data. The UE can adjust the weights for the three factors based on predicted data usage.

As another example, when the type of service is mobility, the UE can predict whether data will be required within a threshold time period in the future. The UE can adjust the weights to have a suitable combination of bandwidth and RSRP based on the prediction. For example, the UE can prioritize (e.g., use a higher weight) RSRP as compared to bandwidth when the predictive traffic pattern algorithm indicates that data will be expected shortly. In some examples, the UE can balance bandwidth and RSRP by assigning equal weights to bandwidth and RSRP. The equal weights for bandwidth and RSRP can be higher than a weight assigned to subcarrier spacing.

In some implementations, the UE can determine the weights based on factors other than the type of service. For example, the weights can be adjusted based on status indicators of the UE (e.g., battery power status). In some examples, the weights can be determined based on a combination of the status indicators and the type of service. In some examples, the weights can be determined based on status indicators regardless of the type of service. When there is no status indicator on the UE, the weights can be more aligned towards performance and/or user experience. In some examples, allocating more weight towards higher bandwidth leads to an increase in battery usage. When the UE has a power saving or low battery indication, the weights can be modified to save power. For example, the UE can prioritize channel conditions (e.g., RSRP) over bandwidth. In some examples, the UE can prioritize subcarrier spacing over bandwidth.

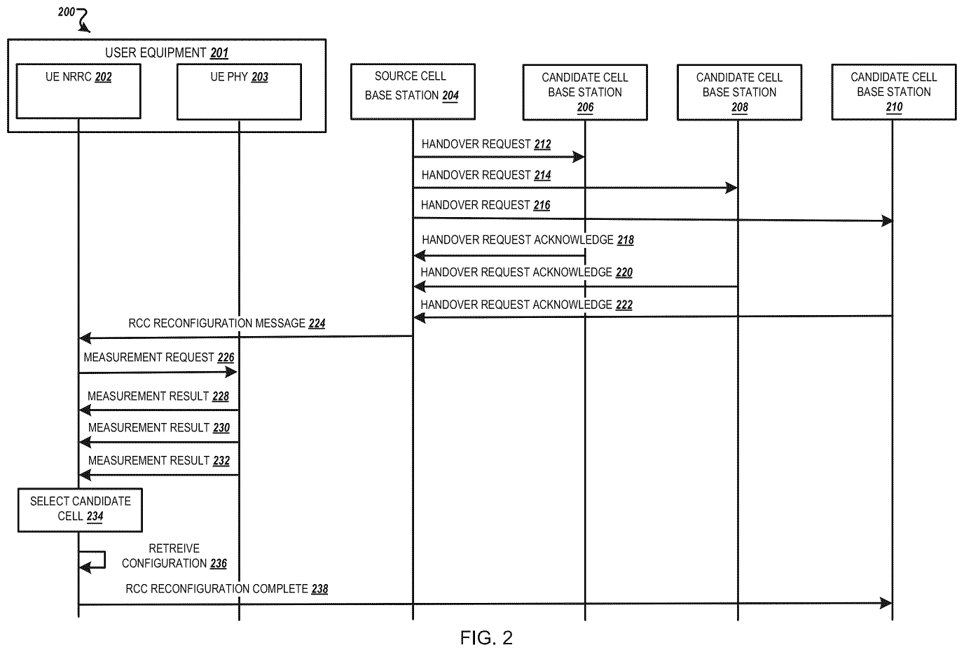

FIG. 2 illustrates a message sequence diagram 200 for conditional handover, according to some implementations. The message sequence diagram 200 includes a UE 201, a source cell base station 204 in the serving cell, and a plurality of base stations in the candidate cells, e.g., candidate cell base station 206, candidate cell base station 208, and candidate cell base station 210. In some implementations, UE 201 is the same or similar to the UE 102 and the source cell base station 204 is the same or similar to the base station 104. As shown, UE 201 includes UE NRRC 202 and UE physical layer (PHY) 203, among other components.

The base station 204 can send handover requests to base stations 206-210 in the candidate cells. The base station sends handover request 212 to candidate cell base station 206, handover request 214 to candidate cell base station 208, and handover request 216 to candidate cell base station 210. The candidate cell base stations 206-210 can reserve resources and acknowledge that they are in a state to accept the handover. The source cell base station 204 can receive a handover request acknowledge 218 from candidate cell base station 206, a handover request acknowledge 220 from candidate cell base station 208, and a handover request acknowledge 222 from candidate cell base station 210. The handover request acknowledges 218-222 include information of bandwidth and subcarrier spacing for the respective candidate cell base stations 206-210. The UE NRRC 202 can receive RRC reconfiguration message 224 from the source cell base station 204. The RRC reconfiguration message 224 can include a list of possible candidate base stations that are valid for conditional handover (e.g., cells corresponding to base stations 206-210), and the handover factors that the source cell base station 204 received from the candidate base stations.

The UE NRRC 202 can send measurement requests 226 to UE PHY 203 to measure power metrics for one or more of the candidate base stations indicated in the RRC reconfiguration message 224. The UE NRRC 202 can receive measurement results 228-232 from the UE PHY 203. The measurement result 228 can include an RSRP for candidate cell base station 206, the measurement result 230 can include an RSRP for candidate cell base station 208, and the measurement result 232 can include an RSRP for candidate cell base station 210. For example, the measurement request 226 can configure the UE PHY 203 to measure and report RSRP for the candidate cell base stations 206-210. The UE NRRC 202 can evaluate whether the RSRP for candidate cell base stations 206-210 meet measurement criteria.

At 234, the UE NRRC 202 can select the target cell from the candidate cells that meet the measurement criterion. The UE NRRC 202 can select a target cell based on bandwidth, subcarrier spacing, and RSRP. As described in the preceding sections, in some implementations, the UE calculates a final value by assigning weights to the handover factors depending on the type of service being used. The UE NRRC 202 can select the base station with the highest final value as the target cell. For example, the UE NRRC 202 selects the cell served by candidate cell base station 210 as the target cell. As described with respect to the example of table 5, the UE NRRC 202 can select candidate cell 5. As described with respect to the example of table 6, the UE NRRC 202 can select candidate cell 4. At 236, the UE NRRC 202 can retrieve the configuration for the selected target cell. The UE 202 sends RCC reconfiguration complete 238 to perform Conditional Handover on the target cell, e.g., the cell served by candidate cell base station 210.

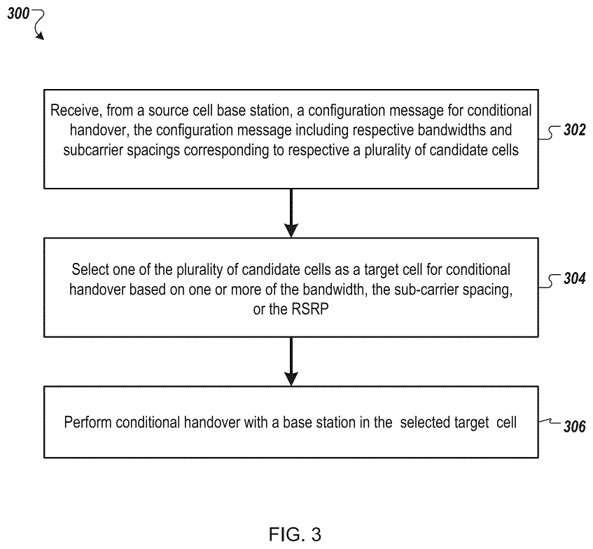

FIG. 3 illustrates a flowchart of an example process 300, according to some implementations. For clarity of presentation, the following description generally describes process 400 in the context of the other figures in this description. For example, process 300 can be performed by the UE 102 of FIG. 1 (and similarly, UE 201 of FIG. 2). It will be understood that process 300 can be performed, for example, by any suitable system, environment, software, hardware, or a combination of systems, environments, software, and hardware, as appropriate. In some implementations, various steps of process 300 can be run in parallel, in combination, in loops, or in any order.

At 302, process 300 involves receiving, from a source base station, a configuration message for conditional handover, the configuration message comprising respective bandwidths and subcarrier spacings corresponding to respective a plurality of candidate cells. For example, UE 102 (UE 201) receives a RRC reconfiguration message 224 from source base station 104 (source cell base station 204) that includes information about bandwidth and subcarrier spacing for candidate cells served by base stations 206, 208, and 210, as described with respect to FIG. 2, along with information identifying the candidate cells (e.g., physical cell identifiers of the candidate cells).

At 304, process 300 involves selecting one of the plurality of candidate cells as a target cell for conditional handover based on one or more of bandwidth, subcarrier spacing, or RSRP. For example, the UE 102 (UE 201) identifies the candidate cells, such as candidate cells served by base stations 206, 208, and 210, using the information provided by the RRC reconfiguration message 224. The UE 102 (UE 201) then measures RSRP for one or more of the identified candidate cells using a physical layer (e.g., UE PHY 203). Upon measuring the RSRP, UE 102 (UE 201) calculates a score (e.g., final value) for candidate cells served by base stations 206, 208, and 210 using a weighted sum of bandwidth, subcarrier spacing, and RSRP, and selects the cell served by candidate cell base station 210 with a highest score as the target cell, as described with respect to FIG. 2.

At 306, process 300 involves performing conditional handover with the selected target cell. For example, UE 102 (UE 201) transmits an RCC reconfiguration complete 238 message to a base station in the target cell, e.g., candidate cell base station 210, as described with respect to FIG. 2.

The example process 300 shown in FIG. 3 can be modified or reconfigured to include additional, fewer, or different steps (not shown in FIG. 3), which can be performed in the order shown or in a different order.

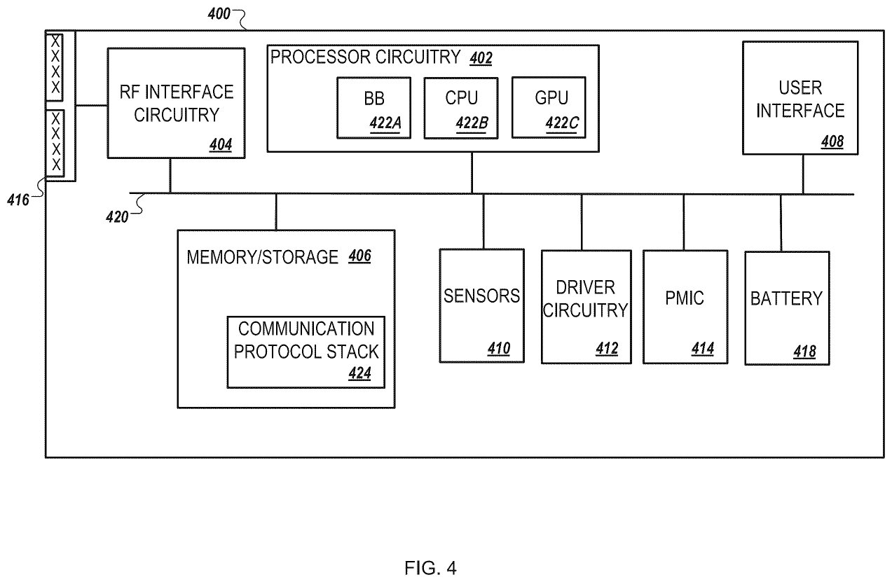

FIG. 4 illustrates a UE 400, according to some implementations. The UE 400 may be similar to and substantially interchangeable with UE 102 of FIG. 1.

The UE 400 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smartwatch), relaxed-IoT devices.

The UE 400 may include processors 402, RF interface circuitry 404, memory/storage 406, user interface 408, sensors 410, driver circuitry 412, power management integrated circuit (PMIC) 414, antenna structure 416, and battery 418. The components of the UE 400 may be implemented as integrated circuits (ICs), portions thereof, discrete electronic devices, or other modules, logic, hardware, software, firmware, or a combination thereof. The block diagram of FIG. 4 is intended to show a high-level view of some of the components of the UE 400. However, some of the components shown may be omitted, additional components may be present, and different arrangements of the components shown may occur in other implementations.

The components of the UE 400 may be coupled with various other components over one or more interconnects 420, which may represent any type of interface, input/output, bus (local, system, or expansion), transmission line, trace, optical connection, etc. that allows various circuit components (on common or different chips or chipsets) to interact with one another.

The processors 402 may include processor circuitry such as, for example, baseband processor circuitry (BB) 422A, central processor unit circuitry (CPU) 422B, and graphics processor unit circuitry (GPU) 422C. The processors 402 may include any type of circuitry or processor circuitry that executes or otherwise operates computer-executable instructions, such as program code, software modules, or functional processes from memory/storage 406 to cause the UE 400 to perform operations as described herein.

In some implementations, the baseband processor circuitry 422A may access a communication protocol stack 424 in the memory/storage 406 to communicate over a 3GPP compatible network. In general, the baseband processor circuitry 422A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 404. The baseband processor circuitry 422A may generate or process baseband signals or waveforms that carry information in 3GPP-compatible networks. In some implementations, the waveforms for NR may be based on cyclic prefix orthogonal frequency division multiplexing (OFDM) “CP-OFDM” in the uplink or downlink, and discrete Fourier transform spread OFDM “DFT-S-OFDM” in the uplink.

The memory/storage 406 may include one or more non-transitory, computer-readable media that includes instructions (for example, communication protocol stack 424) that may be executed by one or more of the processors 402 to cause the UE 400 to perform various operations described herein. The memory/storage 406 includes any type of volatile or non-volatile memory that may be distributed throughout the UE 400. In some implementations, some of the memory/storage 406 may be located on the processors 402 themselves (for example, L1 and L2 cache), while other memory/storage 406 is external to the processors 402 but accessible thereto via a memory interface. The memory/storage 406 may include any suitable volatile or non-volatile memory such as, but not limited to, dynamic random access memory (DRAM), static random access memory (SRAM), erasable programmable read-only memory (EPROM), electrically erasable programmable read-only memory (EEPROM), Flash memory, solid-state memory, or any other type of memory device technology.

The RF interface circuitry 404 may include transceiver circuitry and a radio frequency front module (RFEM) that allows the UE 400 to communicate with other devices over a radio access network. The RF interface circuitry 404 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 416 and proceed to filter and amplify (with a low-noise amplifier) the signal. The signal may be provided to a receiver of the transceiver that downconverts the RF signal into a baseband signal that is provided to the baseband processor of the processors 402.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 416. In various implementations, the RF interface circuitry 404 may be configured to transmit/receive signals in a manner compatible with NR access technologies.

The antenna 416 may include antenna elements to convert electrical signals into radio waves to travel through the air and convert received radio waves into electrical signals. The antenna elements may be arranged into one or more antenna panels. The antenna 416 may have antenna panels that are omnidirectional, directional, or a combination thereof to enable beamforming and multiple input, multiple output communications. The antenna 416 may include microstrip antennas, printed antennas fabricated on the surface of one or more printed circuit boards, patch antennas, phased array antennas, etc. The antenna 416 may have one or more panels designed for specific frequency bands including bands in FR1 or FR2.

The user interface 408 includes various input/output (I/O) devices designed to enable user interaction with the UE 400. The user interface 408 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual displays, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 400.

The sensors 410 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 412 may include software and hardware elements that operate to control particular devices that are embedded in the UE 400, attached to the UE 400, or otherwise communicatively coupled with the UE 400. The driver circuitry 412 may include individual drivers allowing other components to interact with or control various input/output (I/O) devices that may be present within, or connected to the UE 400. For example, driver circuitry 412 may include a display driver to control and allow access to a display device, a touchscreen driver to control and allow access to a touchscreen interface, sensor drivers to obtain sensor readings of sensor circuitry 410 and control and allow access to sensor circuitry 410, drivers to obtain actuator positions of electro-mechanic components or control and allow access to the electro-mechanic components, a camera driver to control and allow access to an embedded image capture device, audio drivers to control and allow access to one or more audio devices.

The PMIC 414 may manage power provided to various components of the UE 400. In particular, with respect to the processors 402, the PMIC 414 may control power-source selection, voltage scaling, battery charging, or DC-to-DC conversion.

In some implementations, the PMIC 414 may control, or otherwise be part of, various power-saving mechanisms of the UE 400. A battery 418 may power the UE 400, although in some examples, the UE 400 may be mounted deployed in a fixed location, and may have a power supply coupled to an electrical grid. The battery 418 may be a lithium-ion battery, a metal-air battery, such as a zinc-air battery, an aluminum-air battery, a lithium-air battery, and the like. In some implementations, such as in vehicle-based applications, the battery 418 may be a typical lead-acid automotive battery.

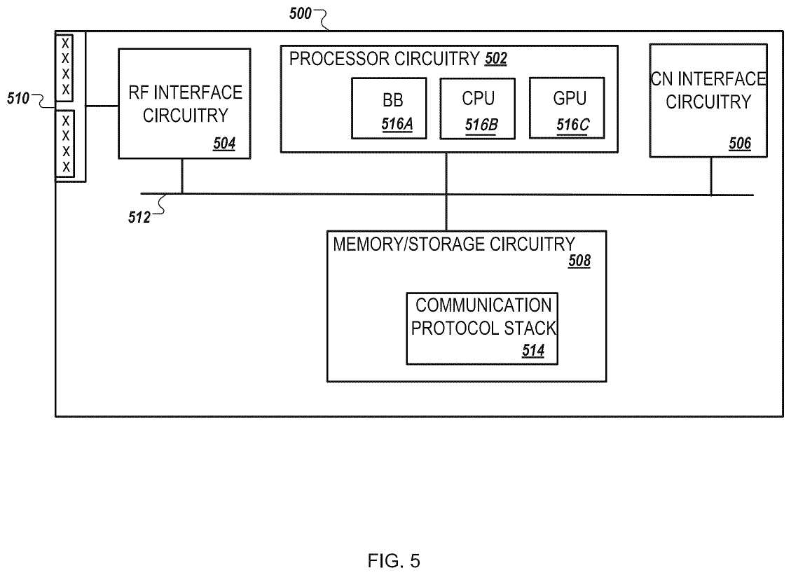

FIG. 5 illustrates an access node 500 (e.g., a base station or gNB), according to some implementations. The access node 500 may be similar to and substantially interchangeable with base station 104. The access node 500 may include processor circuitry 502, RF interface circuitry 504, core network (CN) interface circuitry 506, memory/storage circuitry 508, and antenna structure 510.

The components of the access node 500 may be coupled with various other components over one or more interconnects 512. The processor circuitry 502, RF interface circuitry 504, memory/storage circuitry 508 (including communication protocol stack 514), antenna structure 510, and interconnects 512 may be similar to like-named elements shown and described with respect to FIG. 4. For example, the processor circuitry 502 may include processor circuitry such as, for example, baseband processor circuitry (BB) 516A, central processor unit circuitry (CPU) 516B, and graphics processor unit circuitry (GPU) 516C.

The CN interface circuitry 506 may provide connectivity to a core network, for example, a 5th Generation Core network (5GC) using a 5GC-compatible network interface protocol such as carrier Ethernet protocols, or some other suitable protocol. Network connectivity may be provided to/from the access node 500 via a fiber optic or wireless backhaul. The CN interface circuitry 506 may include one or more dedicated processors or FPGAs to communicate using one or more of the aforementioned protocols. In some implementations, the CN interface circuitry 506 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 500 that operates in an NR or 5G system (for example, a gNB), and the term “E-UTRAN node” or the like may refer to an access node 500 that operates in an LTE or 4G system (e.g., an eNB). According to various implementations, the access node 500 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 500 may be implemented as one or more software entities running on server computers as part of a virtual network, which may be referred to as a CRAN and/or a virtual baseband unit pool (vBBUP). In V2X scenarios, the access node 500 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

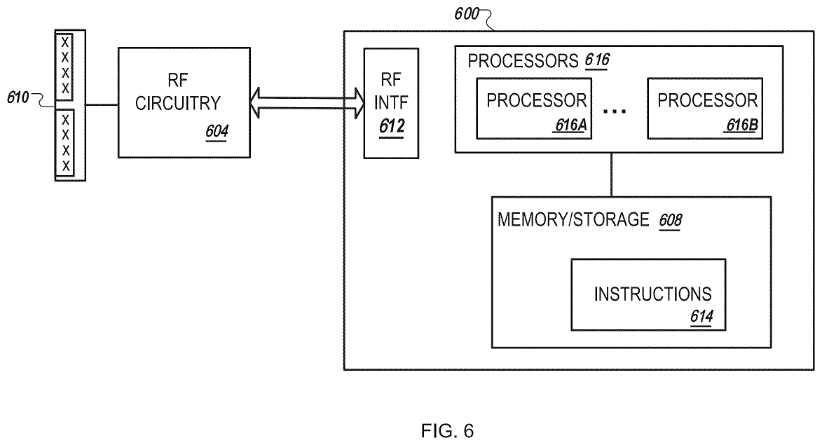

FIG. 6 is a block diagram of an example apparatus 600, according to some implementations. In some implementations, the apparatus 600 includes a baseband processor circuitry. For example, the apparatus 600 may be similar to the baseband processor circuitry (BB) 422A of FIG. 4 or the baseband processor circuitry 516A of FIG. 5 in some cases.

As shown, the apparatus 600 includes one or more processors 616A and 616B, and memory/storage 608 storing instructions 614 that are executed by the one or more processors 616A and 616B. Although FIG. 6 illustrates the apparatus 600 as having multiple processors, in some cases the apparatus 600 can include a single processor (e.g., one of processor 616A or processor 616B).

The apparatus 600 is electrically and communicatively coupled, through RF interface 612, to RF circuitry 604 and associated antenna structure 610. In some implementations, one or more of the processors 616A and 616B execute the instructions 614 to control communications through the RF interface circuitry 604 and antenna structure 610. For example, the one or more processors 616A and 616B may execute the instructions 614 to generate or process baseband signals or waveforms that carry information using wireless channels, and/or manage the radio functions of RF circuitry 604 and antenna structure 610, such as signal modulation, encoding, radio frequency shifting, in addition or as an alternative to the user plane or control plane functions as described with respect to the baseband processor circuitry 422A of FIG. 4 and the baseband processor circuitry 516A of FIG. 5. In doing so, the apparatus 600 enables communication, e.g., wireless cellular communication, over a 3GPP compatible network.

Additionally, in some implementations, the apparatus 600 may include wireless hardware connectivity interface(s) to send/receive data to/from Near Field Communication (NFC) components, Bluetooth® components (e.g., Bluetooth® Low Energy), Wi-Fi® components, and other communication components, and a power management interface (e.g., an interface to send/receive power). In such implementations, the instructions 614 may include instructions that, when executed by one or more of the processors 616A and 616B, cause these processors to perform Wi-Fi communications on an 802.11 network, and/or perform Bluetooth communications.

In some implementations, one or more of the processors 616A and 616B is a 3G baseband processor, a 4G baseband processor, a 5G baseband processor, or other suitable baseband processor. In some implementations, one or more of the processors 616A and 616B may be configured as an FPGA (Field Programmable Gate Array), and/or may have dedicated hardware components, which may include an ASIC (Application Specific Integrated Circuit).

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112 (f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc., as described above in connection with one or more of the preceding figures may be configured to operate in accordance with one or more of the examples set forth below in the example section.

### Examples

In the following sections, further exemplary embodiments are provided.

Example 1 includes a method for wireless communication, the method comprising: receiving, from a source base station in a serving cell, a configuration message for conditional handover, the configuration message comprising respective bandwidths and subcarrier spacings corresponding to respective a plurality of candidate cells; measuring reference signal received power (RSRP) for one or more of the plurality of candidate cells; selecting one of the plurality of candidate cells as a target cell for conditional handover based on one or more of the bandwidth, the subcarrier spacing, or the RSRP; and performing conditional handover to the target cell.

Example 2 includes the method of example 1, wherein the configuration message is a radio resource control (RRC) reconfiguration message.

Example 3 includes the method of example 1, further comprising: determining a difference in RSRP between the serving cell and each of the one or more candidate cells of the plurality of candidate cells, wherein the target cell is selected based on the difference in RSRP for each of the one or more candidate cells.

Example 4 includes the method of example 1, wherein selecting one of the plurality of candidate cells as the target cell based on one or more of the bandwidth, the subcarrier spacing, or the RSRP comprises: for each of the one or more candidate cells of the set of candidate cells: scaling one or more of the bandwidth, the subcarrier spacing, or the RSRP; and determining a score based on a weighted sum of the scaled one or more of the bandwidth, the subcarrier spacing, or the RSRP; and selecting the candidate cell with the highest score as the target cell.

Example 5 includes the method of example 4, wherein selecting the target cell from the plurality of candidate cells comprises: determining whether the UE is downloading data from the source base station; and in response to determining that the UE is downloading data from the source base station, selecting weights for the weighted sum to prioritize bandwidth.

Example 6 includes the method of example 5, wherein selecting the weights for one or more of the bandwidth, the subcarrier spacing or the RSRP to prioritize the bandwidth comprises assigning a higher weight to the bandwidth compared to weights assigned to subcarrier spacing or RSRP

Example 7 includes the method of example 4, wherein selecting the target cell from the plurality of candidate cells comprises: determining whether the UE is downloading data from the source base station; and in response to determining that the UE is not downloading data from the source base station, selecting weights for the weighted sum to prioritize the RSRP.

Example 8 includes the method of example 7, wherein selecting the weights for one or more of the bandwidth, the subcarrier spacing or the RSRP to prioritize the RSRP comprises assigning a higher weight to the RSRP compared to weights assigned to bandwidth or subcarrier spacing

Example 9 includes the method of example 4, wherein selecting the target cell from the plurality of candidate cells comprises: determining whether the UE is in power saving mode; and in response to determining that the UE is in power saving mode, selecting weights for the weighted sum to prioritize the RSRP.

Example 10 includes the method of example 4, wherein selecting the target cell from the plurality of candidate cells comprises: determining whether the UE has a low battery indication; and in response to determining that the UE has a low battery indication, selecting weights for the weighted sum to prioritize the RSRP.

Example 11 includes the method of example 4, wherein weights for the weighted sum are determined dynamically based on predicted traffic patterns.

Example 12 includes the method of example 4, wherein selecting the target cell from the plurality of candidate cells comprises: determining that a predictive traffic pattern of the UE indicates that the UE will increase data usage; and selecting weights for the weighted sum to balance bandwidth and the RSRP.

Example 13 includes the method of example 4, wherein weights for the weighted sum of the scaled one or more of the bandwidth, the subcarrier spacing, or the RSRP are normalized to add up to one.

Example 14 includes an apparatus comprising one or more baseband processors configured to perform operations comprising: receiving, from a source base station in a serving cell, a configuration message for conditional handover, the configuration message comprising respective bandwidths and subcarrier spacings corresponding to respective a plurality of candidate cells; measuring reference signal received power (RSRP) for one or more of the plurality of candidate cells; selecting one of the plurality of candidate cells as a target cell for conditional handover based on one or more of the bandwidth, the subcarrier spacing, or the RSRP; and performing conditional handover to the target cell.

Example 15 may include one or more non-transitory computer-readable media including instructions to cause an electronic device, upon execution of the instructions by one or more processors of the electronic device, to perform one or more elements of a method described in or related to any of examples 1-13, or any other method or process described herein.

Example 16 may include an apparatus including logic, modules, or circuitry to perform one or more elements of a method described in or related to any of examples 1-13, or any other method or process described herein.

Example 17 may include a method, technique, or process as described in or related to any of examples 1-13, or portions or parts thereof.

Example 18 may include an apparatus including: one or more processors and one or more computer-readable media including instructions that, when executed by the one or more processors, cause the one or more processors to perform the method, techniques, or process as described in or related to any of examples 1-13, or portions thereof.

Example 19 may include a signal as described in or related to any of examples 1-11, or portions or parts thereof.

Example 20 may include a datagram, information element, packet, frame, segment, PDU, or message as described in or related to any of examples 1-13, or portions or parts thereof, or otherwise described in the present disclosure.

Example 21 may include a signal encoded with data as described in or related to any of examples 1-13, or portions or parts thereof, or otherwise described in the present disclosure.

Example 22 may include a signal encoded with a datagram, IE, packet, frame, segment, PDU, or message as described in or related to any of examples 1-13, or portions or parts thereof, or otherwise described in the present disclosure.

Example 23 may include an electromagnetic signal carrying computer-readable instructions, wherein execution of the computer-readable instructions by one or more processors is to cause the one or more processors to perform the method, techniques, or process as described in or related to any of examples 1-13, or portions thereof.

Example 24 may include a computer program including instructions, wherein execution of the program by a processing element is to cause the processing element to carry out the method, techniques, or process as described in or related to any of examples 1-13, or portions thereof. The operations or actions performed by the instructions executed by the processing element can include the methods of any one of examples 1-13.

Example 25 may include a signal in a wireless network as shown and described herein.

Example 26 may include a method of communicating in a wireless network as shown and described herein.

Example 27 may include a system for providing wireless communication as shown and described herein. The operations or actions performed by the system can include the methods of any one of examples 1-13.

Example 28 may include a device for providing wireless communication as shown and described herein. The operations or actions performed by the device can include the methods of any one of examples 1-13.

The previously-described examples 1-13 are implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

An apparatus e.g., a UE or one or more baseband processors, among others, can be configured to perform particular operations or actions by virtue of having software, firmware, hardware, or a combination of them installed on the apparatus that in operation causes or cause the apparatus to perform the operations or actions described in any of examples 1-13.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

We claim:

1. A method comprising:
receiving, from a source base station in a serving cell, a configuration message for conditional handover, the configuration message comprising respective bandwidths and subcarrier spacings corresponding to respective a plurality of candidate cells;
measuring one or more reference signal received powers (RSRPs) for one or more of the plurality of candidate cells;
selecting one of the one or more of the plurality of candidate cells as a target cell for the conditional handover based on one or more of the bandwidths, the subcarrier spacings, or the RSRPs; and
performing the conditional handover to the target cell.

2. The method of claim 1, wherein the configuration message is a radio resource control (RRC) reconfiguration message.

3. The method of claim 1, further comprising:
determining a difference in RSRP between the serving cell and each of the one or more candidate cells of the plurality of candidate cells,
wherein the target cell is selected based on the difference in RSRP for each of the one or more candidate cells.

4. The method of claim 1, wherein the method is performed by a user equipment (UE), and wherein selecting one of the plurality of candidate cells as the target cell based on one or more of the bandwidth, the subcarrier spacing, or the RSRP comprises:
for each of the one or more candidate cells of the plurality of candidate cells:
scaling one or more of the bandwidth, the subcarrier spacing, or the RSRP;
assigning weights to the scaled one or more of the bandwidth, the subcarrier spacing or the RSRP; and
determining a score based on a weighted sum of the scaled one or more of the bandwidth, the subcarrier spacing, or the RSRP; and
selecting the candidate cell with a highest score as the target cell.

5. The method of claim 4, wherein selecting the target cell from the plurality of candidate cells comprises:
determining whether the UE is downloading data over a network connection using the source base station; and
in response to determining that the UE is downloading data over the network connection using the source base station, selecting weights for one or more of the bandwidth, the subcarrier spacing or the RSRP to prioritize the bandwidth.

6. The method of claim 5, wherein selecting the weights for one or more of the bandwidth, the subcarrier spacing, or the RSRP to prioritize the bandwidth comprises assigning a higher weight to the bandwidth compared to weights assigned to subcarrier spacing or RSRP.

7. The method of claim 4, wherein selecting the target cell from the plurality of candidate cells comprises:
determining whether the UE is downloading data over a network connection using the source base station; and
in response to determining that the UE is not downloading data over the network connection using the source base station, selecting weights for one or more of the bandwidth, the subcarrier spacing, or the RSRP to prioritize the RSRP.

8. The method of claim 7, wherein selecting the weights for one or more of the bandwidth, the subcarrier spacing, or the RSRP to prioritize the RSRP comprises assigning a higher weight to the RSRP compared to weights assigned to the bandwidth or the subcarrier spacing.

9. The method of claim 4, wherein selecting the target cell from the plurality of candidate cells comprises:
determining whether the UE is in power saving mode; and
in response to determining that the UE is in power saving mode, selecting weights for one or more of the bandwidth, the subcarrier spacing, or the RSRP to prioritize the RSRP.

10. The method of claim 4, wherein selecting the target cell from the plurality of candidate cells comprises:
determining whether the UE has a low battery indication; and
in response to determining that the UE has the low battery indication, selecting weights for one or more of the bandwidth, the subcarrier spacing, or the RSRP to prioritize the RSRP.

11. The method of claim 4, wherein weights for one or more of the bandwidth, the subcarrier spacing, or the RSRP are determined dynamically based on predicted traffic patterns.

12. The method of claim 4, wherein selecting the target cell from the plurality of candidate cells comprises:
determining that a predictive traffic pattern of the UE indicates that the UE will increase data usage; and
selecting weights for one or more of the bandwidth, the subcarrier spacing, or the RSRP to balance bandwidth and RSRP.

13. The method of claim 4, wherein weights for one or more of the bandwidth, the subcarrier spacing, or the RSRP are normalized to add up to one.

14. A non-transitory computer storage medium encoded with instructions that, when executed, cause one or more processors to perform operations comprising:
receiving, from a source base station in a serving cell, a configuration message for conditional handover, the configuration message comprising respective bandwidths and subcarrier spacings corresponding to respective a plurality of candidate cells;
measuring reference signal received power (RSRP) for each of the plurality of candidate cells;
selecting one of the plurality of candidate cells as a target cell for the conditional handover based on one or more of the bandwidth, the subcarrier spacing, or the RSRP; and
performing the conditional handover to the target cell.

15. An apparatus comprising:
one or more processors; and
memory storing instructions that, when executed, are configured to cause the one or more processors to perform operations comprising:
receiving, from a source base station in a serving cell, a configuration message for conditional handover, the configuration message comprising respective bandwidths and subcarrier spacings corresponding to respective a plurality of candidate cells;
measuring reference signal received power (RSRP) for one or more of the plurality of candidate cells;
selecting one of the plurality of candidate cells as a target cell for the conditional handover based on one or more of the bandwidth, the subcarrier spacing, or the RSRP; and
performing the conditional handover to the target cell.

16. The apparatus of claim 15, wherein the configuration message is a radio resource control (RRC) reconfiguration message.

17. The apparatus of claim 15, the operations further comprising:
determining a difference in RSRP between the serving cell and each of the one or more candidate cells of the plurality of candidate cells,
wherein the target cell is selected based on the difference in RSRP for each of the one or more candidate cells.

18. The apparatus of claim 15, wherein selecting the target cell from the plurality of candidate cells based on one or more of the bandwidth, the subcarrier spacing, or the RSRP comprises:
for each of the one or more candidate cells of the plurality of candidate cells:
scaling the one or more of the bandwidth, the subcarrier spacing, or the RSRP;
assigning weights to the scaled one or more of the bandwidth, the subcarrier spacing, or the RSRP; and
determining a score based on a weighted sum of the scaled one or more of the bandwidth, the subcarrier spacing, or the RSRP; and
selecting the candidate cell with a highest score as the target cell.

19. The apparatus of claim 18, wherein selecting the target cell from the plurality of candidate cells comprises:
determining whether a user equipment (UE) is downloading data over a network connection using the source base station; and
in response to determining that the UE is downloading data over the network connection using the source base station, selecting weights for one or more of the bandwidth, the subcarrier spacing, or the RSRP to prioritize the bandwidth.

20. The apparatus of claim 19, wherein selecting the weights for one or more of the bandwidth, the subcarrier spacing, or the RSRP to prioritize the bandwidth comprises assigning a higher weight to the bandwidth compared to weights assigned to subcarrier spacing or RSRP.
